(19) United States
(12) Patent Application Publication
(10) Pub. No.: US 2022/0173472 A1
(43) Pub. Date: Jun. 2, 2022

(54) BATTERY PACK

(71) Applicant: TOYOTA JIDOSHA KABUSHIKI KAISHA, Toyota-shi (JP)

(72) Inventors: Masahiro SAKATA, Nagakute-shi (JP); Akihiro OZEKI, Chiyu-shi (JP)

(73) Assignee: TOYOTA JIDOSHA KABUSHIKI KAISHA, Toyota-shi (JP)

(21) Appl. No.: 17/450,182

(22) Filed: Oct. 7, 2021

(30) Foreign Application Priority Data
Nov. 30, 2020 (JP) 2020-198457

(51) Int. Cl. H01M 50/24; H01M 50/30; H01M 50/227; H01M 50/249; H01M 50/271; H01M 50/502; H01M 50/293; H01M 50/209

(52) U.S. Cl. CPC H01M 50/24; H01M 50/30; H01M 50/227; H01M 50/249; H01M 2220/20; H01M 50/502; H01M 50/293; H01M 50/209; H01M 50/271

(57) ABSTRACT

A battery pack includes a battery stack, gas discharge valves, a housing and a metal plate. The battery stack includes plural battery cells arrayed in a thickness direction. The gas discharge valves are provided at top walls of the battery cells and discharge gas that is produced inside the battery cells. The housing is fabricated of resin and accommodates the battery stack in a hermetically sealed state. The metal plate is disposed inside the housing and opposes the gas discharge valves in a vertical direction.

### CROSS-REFERENCE TO RELATED APPLICATION

This application claims priority under 35 USC 119 from Japanese Patent Application No. 2020-198457 filed on Nov. 30, 2020, the disclosure of which is incorporated by reference herein in its entirety.

### BACKGROUND

### Technical Field

The present disclosure relates to a battery pack.

### Related Art

A battery pack accommodating a battery stack in a pack case fabricated of metal has been known since heretofore (for example, see Japanese Patent Application Laid-Open (JP-A) No 2014-110191).

In this battery pack, high-temperature gas discharged from a valve provided at the battery stack comes into contact with an inner face of the pack case and the temperature of the gas is lowered.

### SUMMARY

However, when a pack case is fabricated of resin in order to reduce the weight of a battery pack, there is a risk of the pack case being melted by the high-temperature gas discharged from the valve provided at the battery stack.

Accordingly, an object of the present disclosure is to provide a battery pack that, even when a housing accommodating a battery stack is fabricated of resin, may prevent the housing being melted by gas produced from the battery stack.

### Solution to Problem

In order to achieve the object described above, a battery pack according to a first aspect includes: a battery stack including plural battery cells arrayed in a thickness direction; a gas discharge valve provided at a top wall of the plurality of battery cells, the gas discharge valve discharging gas that is produced inside the plurality of battery cells; a housing fabricated of resin that accommodates the battery stack in a hermetically sealed state; and a metal plate disposed inside the housing, the metal plate opposing the gas discharge valve in a vertical direction.

According to the battery pack according to the first aspect, gas discharged from the gas discharge valve provided in the top wall of a battery cell comes into contact with the metal plate that opposes the gas discharge valve in the vertical direction. Therefore, heat energy of the gas is absorbed by the metal plate, and heat energy of the gas that fills the interior of the housing fabricated of resin is reduced. As a result, even though the housing is fabricated of resin, melting of the housing by the gas produced from the battery stack is prevented.

In a battery pack according to a second aspect, in the battery pack according to the first aspect, in a sectional view seen in a direction along the thickness direction, the metal plate is formed substantially in an inverted U shape.

According to the battery pack according to the second aspect, the metal plate is formed in the substantial inverted “U” shape in the sectional view seen in the direction along the thickness direction of the battery cells. Therefore, gas that is discharged from the gas discharge valve of the battery cells and comes into contact with the metal plate is guided by the metal plate and flows toward the lower side, causing convection inside the housing. As a result, heat energy of the gas is further reduced.

In a battery pack according to a third aspect, the battery pack according to the first aspect or the second aspect further includes a check valve provided at the housing, the check valve exhausting the gas discharged from the gas discharge valve to outside the housing.

According to the battery pack according to the third aspect, the check valve that exhausts gas discharged from the gas discharge valve to outside the housing is provided at the housing. That is, the gas whose heat energy has been reduced is exhausted outside the housing by the check valve. Therefore, cracking of the hermetically sealed housing by internal pressure due to the housing being filled with the gas is prevented.

In a battery pack according to a fourth aspect, in the battery pack according to any one of the first to third aspects, in a plan view, the gas discharge valve is provided at a substantially central portion of the top wall in a direction intersecting the thickness direction.

According to the battery pack according to the fourth aspect, in plan view, the gas discharge valve is provided at the substantially central portion of the top wall of the battery cell in the direction intersecting the thickness direction. Therefore, the gas produced inside the battery cell is discharged more efficiently than in a structure in which, in plan view, a gas discharge valve is provided at one end portion side of the top wall of a battery cell in the direction intersecting the thickness direction.

In a battery pack according to a fifth aspect, the battery pack according to any one of the first to fourth aspects further includes a reinforcing member disposed inside the housing, the reinforcing member being formed in a frame shape capable of accommodating the battery stack at an inner side thereof, wherein the metal plate is disposed at an upper end portion of the reinforcing member.

According to the battery pack according to the fifth aspect, the metal plate is disposed at the upper end portion of the reinforcing member disposed inside the housing. Therefore, even when a load is applied in the thickness direction of the battery cell, the metal plate acts as a bracing rod and withstand load performance is assured.

In a battery pack according to a sixth aspect, in the battery pack according to any one of the first to fifth aspects, the battery stack is an auxiliary power source.

According to the battery pack according to the sixth aspect, the battery stack is an auxiliary power source. Therefore, when the battery pack is mounted in, for example, a self-driving vehicle, even if a main power source ceases to function due to a malfunction or the like, running for some distance is possible. Thus, the self-driving vehicle may be moved to a safe location.

In a battery pack according to a seventh aspect, the battery pack according to any one of the first to seventh aspects further includes: a side lid portion that closes off an opening portion formed in one side portion of the housing; and an upper lid portion that closes off an opening portion formed in an upper portion of the housing, wherein the side lid portion includes an engaged portion with which an engaging portion formed at the upper lid portion engages.

According to the battery pack according to the seventh aspect, the side lid portion includes the engaged portion with which the engaging portion formed at the upper lid portion is engaged. Therefore, compared with a structure in which a housing includes an engaged portion with which an engaging portion formed at an upper lid portion is engaged, a height of the housing is reduced, and the size of the battery pack is reduced by a corresponding amount.

In a battery pack according to an eighth aspect, the battery pack according to any one of the first to seventh aspects further includes: a side lid portion that closes off an opening portion formed in one side portion of the housing; and a busbar that electrically connects an electrode terminal provided at the battery stack with an electrode terminal provided at the side lid portion, wherein the side lid portion includes a tilting prevention portion that prevents tilting of the busbar at a time of attachment of the busbar.

According to the battery pack according to the eighth aspect, the side lid portion includes the tilting prevention portion that prevents tilting of the busbar at the time of attachment of the busbar. Therefore, ease of operation of attaching the busbar is improved compared with a structure in which a side lid portion does not include a tilting prevention portion.

In a battery pack according to a ninth aspect, in the battery pack according to the eighth aspect, the tilting prevention portion includes a slit portion into which a pawl portion formed at the busbar is inserted.

According to the battery pack according to the ninth aspect, the tilting prevention portion is structured by the slit portion into which the pawl portion formed at the busbar is inserted. Therefore, the structure of the tilting prevention portion is simplified compared with a structure in which a tilting prevention portion is separately provided.

### Effects

As described above, according to the present disclosure, even when the housing accommodating the battery stack is fabricated of resin, melting of the housing by gas produced from the battery stack may be prevented.

### BRIEF DESCRIPTION OF THE DRAWINGS

Preferred embodiments will be described in detail based on the following figures, wherein:

FIG. 1 is an exploded perspective view showing a battery pack according to a present exemplary embodiment.

FIG. 2 is an exploded perspective view showing a reinforcing member provided in a case of the battery pack according to the present exemplary embodiment.

FIG. 3 is an exploded perspective view showing a magnification of engaging portions of a cover member of the battery pack according to the present exemplary embodiment and engaged portions of a connector module.

FIG. 4 is an exploded perspective view showing a magnification of a connecting structure of a busbar that electrically connects a battery stack of the battery pack according to the present exemplary embodiment with the connector module.

FIG. 5 is a schematic view showing a section of the battery pack according to the present exemplary embodiment.

### DETAILED DESCRIPTION

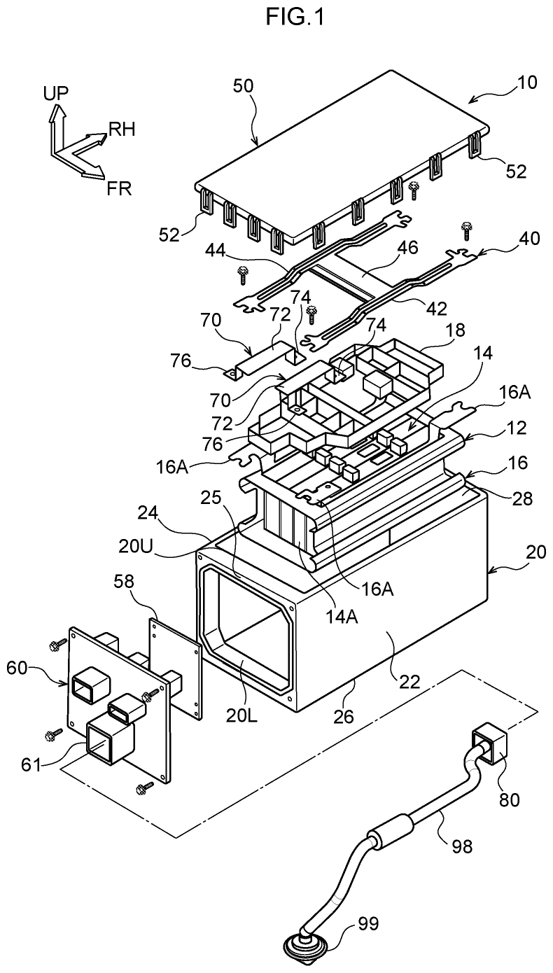

Below, an exemplary embodiment of the present disclosure is described in detail in accordance with the drawings. A battery pack 10 (see FIG. 1) according to the present exemplary embodiment is an auxiliary power source to be mounted at a self-driving vehicle (not shown in the drawings) that runs under electric power. That is, the battery pack 10 is a backup power source for enabling the self-driving vehicle to run some distance if a battery stack that is a main power source (not shown in the drawings) ceases to function due to a malfunction or the like.

For convenience of description, the arrow UP that is shown where appropriate in the drawings represents an upper direction of the battery pack 10, an arrow FR represents a front direction of the battery pack 10, and an arrow RH represents a right direction of the battery pack 10. Therefore, where the directions upper and lower, front and rear, and left and right are recited without being particularly specified in the descriptions below, these represent upper and lower in a vertical direction of the battery pack 10, front and rear in a front-and-rear direction of the battery pack 10, and left and right in a left-and-right direction of the battery pack 10.

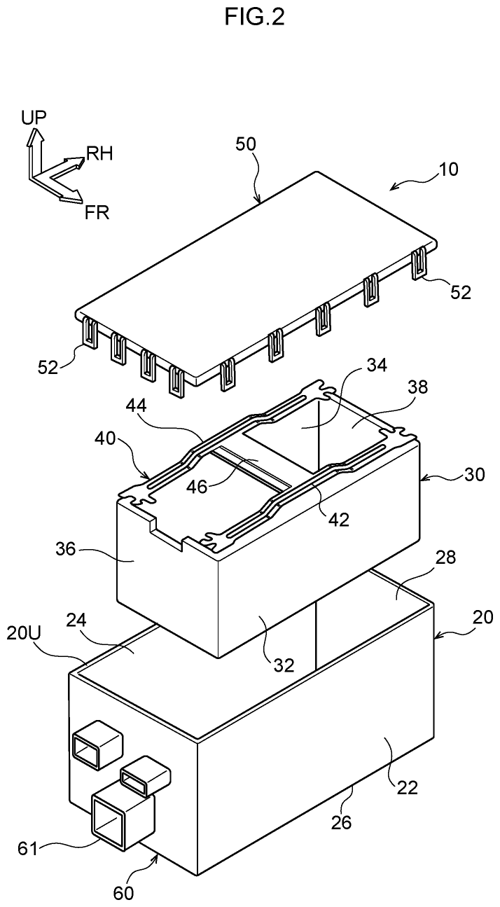

As shown in FIG. 1 and FIG. 2, the battery pack 10 according to the present exemplary embodiment includes a case 20, a reinforcing member 30 (not shown in FIG. 1), a battery stack 12 (not shown in FIG. 2), a busbar module 18 and a flue plate 40. The case 20 is fabricated of resin and serves as a housing. The reinforcing member 30 is fabricated of metal and is arranged along an inner face of the case 20. The battery stack 12 is accommodated at an inner side of the reinforcing member 30 (inside the case 20). The busbar module 18 is provided above the battery stack 12. The flue plate 40 is disposed above the busbar module 18 and serves as a metal plate.

The battery pack 10 according to the present exemplary embodiment further includes a cover member 50, a connector module 60, a monitoring circuit board 58 and a check valve 80. The cover member 50 is fabricated of resin and serves as an upper lid portion that is capable of closing off an opening portion 20U formed in an upper portion of the case 20. The connector module 60 is fabricated of resin and serves as a side lid portion that is capable of closing off an opening portion 20L formed in one side portion (a left side portion) of the case 20. The monitoring circuit board 58 is disposed at the inner side of the connector module 60. The check valve 80 is attached to the outer side of the connector module 60.

The case 20 is formed of a resin material such as, for example, polybutylene terephthalate (PBT) or the like. The case 20 includes a floor wall 26 in a rectangular flat plate shape, a front wall 22 and rear wall 24 in rectangular flat plate shapes, and a right side wall 28 in a rectangular flat plate shape. The longer direction of the floor wall 26 is in the left-and-right direction. The longer directions of the front wall 22 and rear wall 24 are in the left-and-right direction. The longer direction of the right side wall 28 is in the front-and-rear direction. The right side wall 28 corresponds to another side portion (a right side portion).

The left side portion of the case 20 is formed as the opening portion 20L. Upper-left end portions of the front wall 22 and the rear wall 24 are integrally connected by a long, narrow connecting member 25. Thus, the left side portion of the case 20 is formed in a rectangular frame shape. The connector module 60 is attached by screw-fixing or the like to the left side portion formed in this rectangular frame shape. The connector module 60 is formed substantially in a rectangular flat plate shape of a resin material such as, for example, polyphenylene sulfide (PPS) or the like. Thus, the left side portion is closed off.

As shown in FIG. 2, the reinforcing member 30 includes a front wall 32, a rear wall 34, a right side wall 38 and a left side wall 36. The front wall 32 is arranged along an inner face of the front wall 22, the rear wall 34 is arranged along an inner face of the rear wall 24, the right side wall 38 is arranged along an inner face of the right side wall 28, and the left side wall 36 opposes an inner face of the connector module 60. That is, the reinforcing member 30 is formed in a rectangular frame shape (a quadrangular tube shape) that is open in the vertical direction.

The front wall 32 and rear wall 34 of the reinforcing member 30 are formed of, for example, steel plate with a thickness of 1.4 mm, and the left side wall 36 and right side wall 38 are formed of, for example, aluminium plate with a thickness of 5.5 mm. Respective left and right end portions of the reinforcing member 30 and the rear wall 34 are attached to respective front end faces and rear end faces of the left side wall 36 and right side wall 38 by screw-fixing or the like.

The flue plate 40 is disposed at an upper end portion of the front wall 32 and an upper end portion of the rear wall 34 of the reinforcing member 30. The flue plate 40 is formed in a substantial “H” shape in plan view of, for example, steel plate with a thickness of around 2.0 mm. A front arm 42 and a rear arm 44 of the flue plate 40 extend in the left-and-right direction. Respective left and right end portions of the front arm 42 and the rear arm 44 are attached by screw-fixing or the like both to arms 16A protruding from a holder 16, which is described below, and to the upper end portion of the left side wall 36 and upper end portion of the right side wall 38 of the reinforcing member 30.

A connecting portion 46 connects left-and-right direction central portions of the front arm 42 and rear arm 44 of the flue plate 40 (extending in a thickness direction of battery cells 14, which are described below). The connecting portion 46 is disposed between a left-and-right direction central portion of the upper end portion of the front wall 32 and a left-and-right direction central portion of the upper end portion of the rear wall 34. The front arm 42 and the rear arm 44 are formed with a width of the front arm 42 and a width of the rear arm 44 being the same. The connecting portion 46 is formed with a width greater than the widths of the front arm 42 and the rear arm 44.

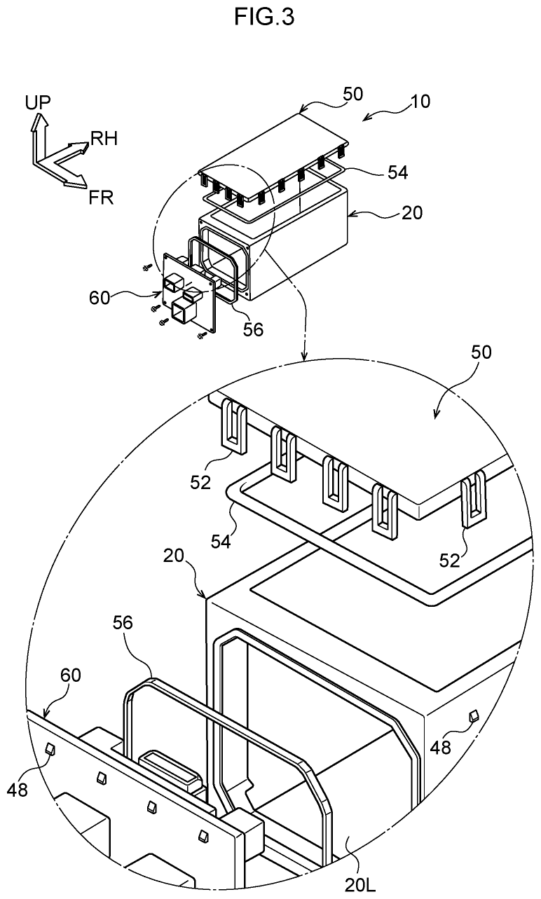

The cover member 50 is formed in a rectangular flat plate shape with substantially the same size as the floor wall 26 of, for example, a resin material such as polyphenylene sulfide (PPS) or the like. As shown in more detail in FIG. 3, plural engaging portions 52 are equidistantly formed integrally at a periphery edge portion of the cover member 50. The engaging portions 52 depend in substantial “U” shapes. Five of the engaging portions 52 are provided at each longer side portion of the cover member 50 and four of the engaging portions 52 are provided at each shorter side portion.

Plural pawl portions 48 are integrally formed at upper end portions of the respective outer faces of the front wall 22, rear wall 24 and right side wall 28 of the case 20. The pawl portions 48 serve as engaged portions with which the respective engaging portions 52 engage. Five of the pawl portions 48 are equidistantly formed at the upper end portions of the outer faces of each of the front wall 22 and the rear wall 24, and four of the pawl portions 48 are equidistantly formed at the upper end portion of the outer face of the right side wall 28. A plural number of the pawl portions 48 are also integrally formed at an upper end portion of an outer face of the connector module 60. These pawl portions 48 also serve as engaged portions with which the engaging portions 52 engage. That is, four of the pawl portions 48 are equidistantly formed at the upper end portion of the outer face of the connector module 60.

A front and rear pair of pins (not shown in the drawings) protrude toward the connecting member 25 from upper end portions of the inner face of the connector module 60. A front and rear pair of fitting holes (not shown in the drawings) are formed in the connecting member 25. The front and rear pair of pins tightly fit into the front and rear pair of fitting holes. Thus, by the pins being tightly fitted into the fitting holes, the connector module 60 is positioned relative to the left side portion of the case 20 and is attached thereto. As a result, the engaging portions 52 formed at the cover member 50 are engaged with the pawl portions 48 formed at the connector module 60 without mispositioning.

An O-ring 54 that serves as a sealing member is provided between the cover member 50 and the upper end portions of the case 20. The O-ring 54 is formed in a rectangular shape in plan view and is arranged along the upper end portions of the front wall 22, the rear wall 24, the right side wall 28 and the connecting member 25. Similarly, an O-ring 56 that serves as a sealing member is provided between the connector module 60 and left side portions of the case 20. The O-ring 56 is formed in a rectangular shape in side view and is arranged along periphery edge portions of the connector module 60 (left end portions of the floor wall 26, front wall 22 and rear wall 24, and the connecting member 25).

Thus, by the cover member 50 being attached to the case 20 with the O-ring 54 interposed and the connector module 60 being attached to the case 20 with the O-ring 56 interposed, the case 20 fabricated of resin that accommodates the battery stack 12 and so forth is formed as a structure that is hermetically sealed in a waterproof and dustproof state.

As shown in FIG. 1, the battery stack 12 includes a plural number (for example, four) of lithium battery cells (below referred to simply as “the battery cells”) 14 and the frame-shaped holder 16 that accommodates the plural battery cells 14. The upper side and both the left and right sides of the holder 16 are open. Each battery cell 14 includes a case 14A that is fabricated of metal (for example, aluminium) and formed in a substantially cuboid shape. The plural battery cells 14 are accommodated side-by-side in the front-and-rear direction in the holder 16, with a thickness direction of the battery cells 14 in the front-and-rear direction. The battery cells 14 are electrically connected in series by the busbar module 18 provided above the battery cells 14. A thermistor and the like are provided at the busbar module 18.

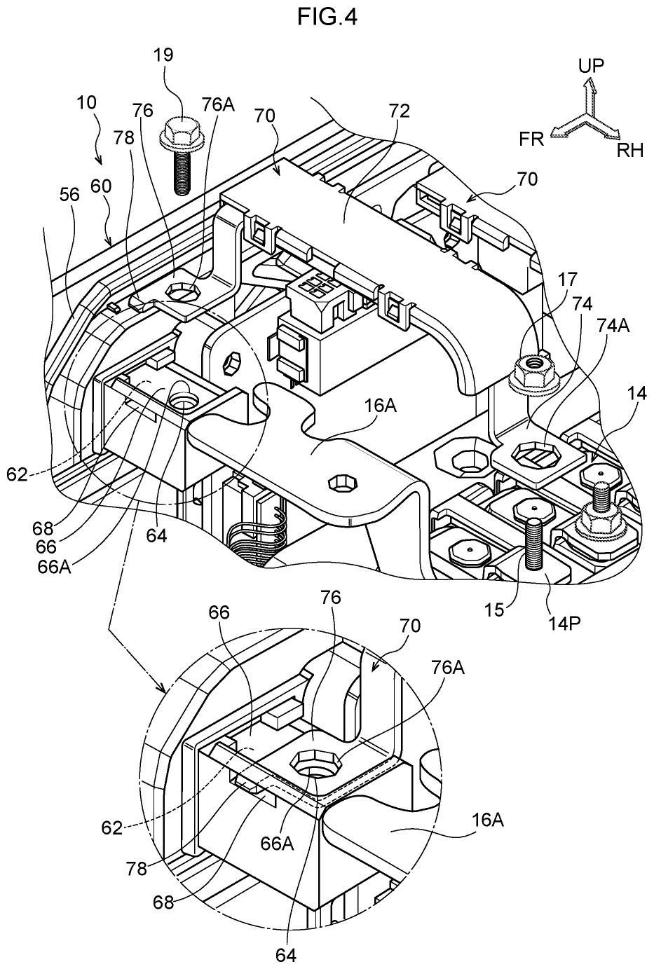

As shown in FIG. 4, a positive electrode terminal 14P at one side in the front-and-rear direction (for example, the front side) of the battery cells 14 and a negative electrode terminal (not shown in the drawings) at the other side in the front-and-direction (for example, the rear side) of the battery cells 14 are electrically connected by a front and rear pair of busbars 70 to respective electrode terminals 66 provided at the connector module 60.

Each busbar 70 includes a main body portion 72 in a long, narrow, substantially rectangular, flat plate shape, a first connecting portion 74 and a second connecting portion 76. The first connecting portion 74 integrally depends from one length direction end portion (a right end portion) of the main body portion 72 and is formed in a curved shape. The second connecting portion 76 integrally depends from one longer edge portion side of the main body portion 72 at the other length direction end portion (a left end portion) of the main body portion 72.

The first connecting portion 74 of the busbar 70 is formed in a substantial “L” shape as seen in the direction along the shorter edge portions of the busbar 70 (the front-and-rear direction). A penetrating hole 74A with a substantially circular shape (more specifically, a regular octagon shape) is formed in a distal end portion of the first connecting portion 74. An axial direction of the penetrating hole 74A is in the vertical direction.

A weld bolt 15 is provided at the positive electrode terminal 14P of the battery cell 14 at the front side, and a weld bolt (not shown in the drawings) is provided at the negative electrode terminal of the battery cell 14 at the rear side. The weld bolts are inserted into the respective penetrating holes 74A of the first connecting portions 74. A nut 17 is screwed onto the weld bolt 15 from the upper side thereof In this manner, the respective first connecting portions 74 of the busbars 70 are connected to the positive electrode terminal 14P of the battery cell 14 at the front side and the negative electrode terminal of the battery cell 14 at the rear side.

The second connecting portions 76 of the busbars 70 depend so as to protrude in opposite directions from one another (the front direction and the rear direction). Each second connecting portion 76 is formed in a substantial “L” shape as seen in the direction along the longer side portions of the busbar 70 (the left-and-right direction). A penetrating hole 76A with a substantially circular shape (more specifically, a regular octagon shape) is formed in a distal end portion of the second connecting portion 76. The axial direction of the penetrating hole 76A is in the vertical direction. A pawl portion 78 in a rectangular flat plate shape is formed integrally with the distal end portion of the second connecting portion 76. The pawl portion 78 extends in the protruding direction of the second connecting portion 76.

A front and rear pair of accommodating recess portions 62 with substantially rectangular shapes in plan view are formed in the upper portion of the inner face of the connector module 60. The electrode terminals 66 are provided in the accommodating recess portions 62. Each electrode terminal 66 is fabricated of metal and electrically connected with the corresponding second connecting portion 76. A penetrating hole 66A with a substantially circular shape is formed in the electrode terminal 66. A female thread portion 64 is formed in a floor portion of the accommodating recess portion 62 with an axial direction of the female thread portion 64 in the vertical direction. The penetrating hole 66A is in communication with the female thread portion 64, and a bolt 19 is screwed into the female thread portion 64.

A slit portion 68 is formed in a periphery edge portion at the front-and-rear direction outer side (the side in the protruding direction of the second connecting portion 76) of each accommodating recess portion 62. The pawl portion 78 is inserted into the slit portion 68. When each pawl portion 78 is inserted into the corresponding slit portion 68, the second connecting portion 76 is disposed at a position at which the penetrating hole 76A is in communication with the penetrating hole 66A and the female thread portion 64.

The second connecting portions 76 are provided only at one longer edge portion side of the other length direction end portion (left end portion) of each main body portion 72 and are not well-balanced between left and right. However, because the pawl portions 78 are inserted into the slit portions 68, tilting of the busbars 70 in directions in which the busbars 70 approach one another is prevented. The slit portions 68 into which the pawl portions 78 are inserted are equivalent to a tilting prevention portion.

As shown in FIG. 1, a fitting portion 61 with a rectangular frame shape is formed at a lower portion of the outer face of the connector module 60. The check valve 80 is tightly fitted and engaged with the inner side of the fitting portion 61. The check valve 80 is for exhausting gas such as carbon monoxide (CO) and the like that is discharged from the battery cells 14 due to abnormal heating and fills the interior of the case 20. One end portion of an exhaust pipe 98 is connected to the check valve 80, and the gas is exhausted to the exterior through the exhaust pipe 98. A grommet 99 is provided at the other end portion of the exhaust pipe 98. The grommet 99 prevents entry of foreign bodies from the exterior.

Now, the flue plate 40 according to the present exemplary embodiment of the battery pack 10 with the structure described above is described in more detail.

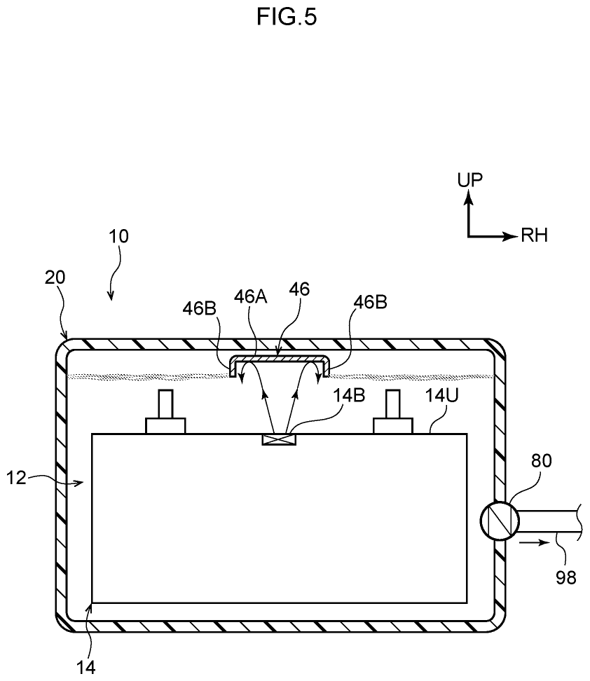

As shown in FIG. 5, the connecting portion 46 of the flue plate 40 is formed substantially in an inverted “U” shape in a sectional view seen in a direction along the length direction of the connecting portion 46 (the thickness direction of the battery cells 14). That is, the connecting portion 46 includes a main body portion 46A with a flat plate shape and flange portions 46B that are formed integrally with the main body portion 46A. The flange portions 46B curve downward at both of left-and-right direction end portions (longer edge portions) of the main body portion 46A. A projection height downward of the flange portions 46B from the main body portion 46A is set at, for example, 2 mm to 4 mm. In the present exemplary embodiment, the projection height is set at 3 mm.

A gas discharge valve 14B is provided at a substantially central portion in the longer direction (the left-and-right direction) of a top wall 14U of the case 14A of each battery cell 14. Therefore, high-temperature gas (carbon monoxide and the like) that is produced inside the battery cell 14 due to abnormal heating and discharged upward through the gas discharge valve 14B directly comes into contact with a lower face of the connecting portion 46 that is disposed directly above the gas discharge valve 14B (opposing the gas discharge valve 14B in the vertical direction).

At least the connecting portion 46 of the flue plate 40 is formed of a metal with a relatively large thermal capacity (for example, steel plate). Therefore, heat energy of the high-temperature gas that is discharged through the gas discharge valves 14B and comes into contact with the lower face of the connecting portion 46 of the flue plate 40 is absorbed by the connecting portion 46.

Because the connecting portion 46 is formed in the substantial inverted “U” shape in the sectional view (because the flange portions 46B are formed at the two left-and-right direction end portions of the main body portion 46A), high-temperature gas that is discharged upward through the gas discharge valves 14B comes into contact with the lower face of the main body portion 46A and then flows toward the lower side, guided by inner faces of the flange portions 46B. That is, gas whose heat energy has been absorbed by the connecting portion 46 is guided toward the lower side by the connecting portion 46, causing convection inside the case 20.

Now, operation of the battery pack 10 according to the present exemplary embodiment that is provided with the flue plate 40 with the structure described above is described.

As described above, each battery cell 14 accommodated in the case 20 of the battery pack 10 may produce high-temperature gas due to abnormal heating. In this exemplary embodiment, the gas discharge valve 14B that discharges the high-temperature gas is provided at the substantially central portion in the longer direction (the left-and-right direction) of the top wall 14U of the case 14A of the battery cell 14.

Therefore, the high-temperature gas may be discharged more efficiently than in a structure in which, for example, the gas discharge valve 14B is provided at one end portion side of the longer direction (the left-and-right direction) of the top wall 14U of the case 14A. In addition, the high-temperature gas discharged from the gas discharge valve 14B directly comes into contact with the lower face of the connecting portion 46 that is disposed directly above the gas discharge valve 14B.

Because the connecting portion 46 is formed of a metal with a large thermal capacity, heat energy of high-temperature gas that comes into contact with the lower face of the connecting portion 46 is plentifully absorbed by the connecting portion 46. Therefore, even if the case 20 is fabricated of resin in order to reduce weight, problems of the case 20 being melted by high-temperature gas produced from the battery cells 14 and, for example, a hole being opened in the front wall 22 or the like (such that the gas leaks into a passenger compartment) may be prevented.

Because the flange portions 46B that project downward are integrally formed at the two left-and-right direction end portions of the main body portion 46A of the connecting portion 46, gas that has come into contact with the lower face of the connecting portion 46 and whose heat energy has been absorbed (whose temperature has been lowered) is guided by the inner faces of the flange portions 46B and flows toward the lower side. Therefore, the gas whose temperature has been lowered causes convection inside the hermetically sealed case 20, and the temperature may be lowered further by natural convection. As a result, problems such as melting of the case 20 may be even further prevented.

Subsequently, if the interior of the hermetically sealed case 20 fabricated of resin is filled with gas discharged from the battery cells 14 and the pressure inside the case 20 rises, the check valve 80 opens and the gas in the case 20 is exhausted through the exhaust pipe 98 from the check valve 80. Therefore, problems such as the hermetically sealed case 20 fabricated of resin being cracked by internal pressure due to the case 20 being filled with the gas may be prevented.

As described above, the connecting portion 46 that connects the left-and-right direction central portions of the front arm 42 and rear arm 44 of the flue plate 40 is disposed between the left-and-right direction central portion of the upper end portion of the front wall 32 and the left-and-right direction central portion of the upper end portion of the rear wall 34. Thus, the connecting portion 46 functions as a bracing rod between the upper end portion of the front wall 32 and the upper end portion of the rear wall 34.

Therefore, even though the case 20 is fabricated of resin rather than metal, strength with respect to an external force (a load) applied in the front-and-rear direction (the thickness direction of the battery cells 14) may be improved. Thus, when a collision load in the front-and-rear direction is applied to the battery pack 10 equipped with the case 20 fabricated of resin, collision resistance (load withstand performance) may be assured.

As described above, the engaging portions 52 of the cover member 50 are engaged with the pawl portions 48 of the connector module 60 that is positioned relative to the case 20. Therefore, compared to a structure in which, for example, the connecting member 25 is disposed at the upper side relative to the connector module 60 and engaging portions are engaged with pawl portions formed at the connecting member 25 (the case 20), the height of the case 20 may be reduced by an amount corresponding to the height of the connecting member 25. In other words, an increase in height of the battery pack 10 may be suppressed by the pawl portions 48 being formed at the upper end portion of the outer face of the connector module 60, and the battery pack 10 may be reduced in size.

As described above, when the penetrating hole 76A of each second connecting portion 76 is put into communication with the penetrating hole 66A and the female thread portion 64 (when the busbar 70 is being attached to the connector module 60), the pawl portion 78 is inserted into the slit portion 68. Therefore, tilting of the busbar 70 in a direction in which the busbars 70 approach one another may be prevented even when fingers are removed from the busbar 70. Hence, the second connecting portion 76 is connected with the electrode terminal 66 by the bolt 19 being inserted into the penetrating hole 76A and the penetrating hole 66A and screwed into the female thread portion 64. Thus, the operation of screwing in the bolt 19 is easy (ease of operation of the attachment may be improved).

Because the busbars 70 do not tilt in the directions approaching one another, occurrences of short circuits and the like may be prevented and safety may be further assured. Because the tilting prevention portions are constituted by the slit portions 68 into which the pawl portions 78 are inserted, the structure may be made simpler than a structure in which tilting prevention portions are separately provided.

Because the battery stack 12 of the battery pack 10 is an auxiliary power source, if a main power source ceases to function due to a malfunction or the like, the vehicle may be run some distance by the battery pack 10 (the battery stack 12). Therefore, for example, a self-driving vehicle may be moved to a safe location or a location where repair is possible.

Above, the battery pack 10 according to the present exemplary embodiment has been described on the basis of the attached drawings. However, the battery pack 10 according to the present exemplary embodiment is not limited to the illustrated structures; suitable design modifications may be applied within a scope not departing from the gist of the present invention. For example, the battery pack 10 according to the present exemplary embodiment may be mounted not only at self-driving vehicles but also at battery electric vehicles and the like that can be manually driven.

The flue plate 40 is not limited to being formed of steel plate; it is sufficient that the flue plate 40 is formed of a metal with a relatively high thermal capacity, such as aluminium, copper or the like. In particular, if the flue plate 40 is formed of copper, the flue plate 40 may also be employed as a bus bar for the battery stack 12. Even if the case 20 is fabricated of a metal, it is useful to provide the flue plate 40.

What is claimed is:

1. A battery pack comprising:
a battery stack including a plurality of battery cells arrayed in a thickness direction;
a gas discharge valve provided at a top wall of the plurality of battery cells, the gas discharge valve discharging gas that is produced inside the plurality of battery cells;
a housing fabricated of resin that accommodates the battery stack in a hermetically sealed state; and
a metal plate disposed inside the housing, the metal plate opposing the gas discharge valve in a vertical direction.

2. The battery pack according to claim 1, wherein, in a sectional view seen in a direction along the thickness direction, the metal plate is formed substantially in an inverted U shape.

3. The battery pack according to claim 1, further comprising a check valve provided at the housing, the check valve exhausting the gas discharged from the gas discharge valve to outside the housing.

4. The battery pack according to claim 1, wherein, in a plan view, the gas discharge valve is provided at a substantially central portion of the top wall in a direction intersecting the thickness direction.

5. The battery pack according to claim 1, further comprising a reinforcing member disposed inside the housing, the reinforcing member being formed in a frame shape capable of accommodating the battery stack at an inner side thereof,
wherein the metal plate is disposed at an upper end portion of the reinforcing member.

6. The battery pack according to claim 1, wherein the battery stack is an auxiliary power source.

7. The battery pack according to claim 1, further comprising:
a side lid portion that closes off an opening portion formed in one side portion of the housing; and
an upper lid portion that closes off an opening portion formed in an upper portion of the housing,
wherein the side lid portion includes an engaged portion with which an engaging portion formed at the upper lid portion engages.

8. The battery pack according to claim 1, further comprising:
a side lid portion that closes off an opening portion formed in one side portion of the housing; and
a busbar that electrically connects an electrode terminal provided at the battery stack with an electrode terminal provided at the side lid portion,
wherein the side lid portion includes a tilting prevention portion that prevents tilting of the busbar at a time of attachment of the busbar.

9. The battery pack according to claim 8, wherein the tilting prevention portion includes a slit portion into which a pawl portion formed at the busbar is inserted.
